(19) United States
(12) Patent Application Publication
(10) Pub. No.: US 2017/0132579 A1
(43) Pub. Date: May 11, 2017

(54) OFFSHORE PLANT PREVENTIVE MAINTENANCE SYSTEM AND OFFSHORE PLANT PREVENTING MAINTENANCE METHOD USING THE SAME

(71) Applicant: Korea Institute of Ocean Science & Technology, Ansan (KR)

(72) Inventor: Ho Jin HWANG, Daejeon (KR)

(21) Appl. No.: 15/144,459

(22) Filed: May 2, 2016

(30) Foreign Application Priority Data
Nov. 10, 2015 (KR) 10-2015-0157763

(51) Int. Cl. G06Q 10/00

(52) U.S. Cl. CPC G06Q 10/20

(57) ABSTRACT

An electronic device is provided. The offshore plant preventive maintenance system includes an information collection part configured to collect information of offshore plant facility and equipment in real time, a preventive maintenance part configured to execute intelligent maintenance activity based on the collected information, and a virtual operation part configured to verify the intelligent maintenance activity. An offshore plant preventive maintenance method using the offshore plant preventive maintenance system is also provided.

### CROSS-REFERENCE TO RELATED APPLICATION(S)

This application claims the benefit under 35 U.S.C. §119(a) of a Korean Patent Application filed on Nov. 10, 2015 in the Korean Intellectual Property Office and assigned Serial number 10-2015-0157763, the entire disclosure of which is hereby incorporated by reference.

### TECHNICAL FIELD

The present disclosure relates to an offshore plant preventive maintenance system, and more particularly, to an offshore plant preventive maintenance system, and an offshore plant preventive maintenance method using the system, capable of applying a preventive maintenance technique, which is a positive and aggressive preventive mode, to an offshore plant.

### BACKGROUND

Offshore plants are generally operated for production activity during a long term more than 20 or 30 years in lifetime in accordance with trends to hybridity and enlargement. Much cost and many efforts are invested in operation and maintenance of offshore plants, being highly over the cost for constructing a new offshore plant. In recent years, oil majors and offshore plant operation companies are interested on the fact that too much cost id spent in operation and maintenance of offshore plants. This interest can be found from Asset Integrity Management (AIM) which is recently arising as an issue.

AIM is totally called an integrated service for entirely checking maintenance of assets and collecting data in order to maximize the productivity by periodic maintenance for facility and equipment. The key functionality is to implement the integration with operation, technology, and design of underwater oil and gas fields through periodic inspection and monitoring.

FIG. 1 is a table divisionally showing kinds of maintenance according to property.

Referring to FIG. 1, a maintenance mode used for maintaining facility and equipment is generally referred to as scheduled maintenance. This is a mode of periodically replacing equipment and components, and frequently utilized in general merchant ships.

It is apparent that this mode is more intelligent than emergency maintenance. It may be pertinent to perform a periodic scheduled maintenance in consideration of bad offshore environment and loss cost caused from failures. The scheduled maintenance is a maintenance mode which is performed in a given period, different from non-scheduled maintenance which is performed at accidents or failures.

Typical modes of the scheduled maintenance are preventive maintenance and aftercare maintenance.

The preventive maintenance is widely known as a maintenance method of preventing equipment for a normal condition. A typical mode is time-based maintenance for preparing and exchanging equipment through periodic inspection and maintenance.

It is apparent that preventive maintenance including traditional preventive maintenance is a good mode for maintaining the functionality of equipment in the best condition.

However, since an offshore plant is relatively expensive equipment, it is difficult for the offshore plant to be dealt by scheduled maintenance.

Recently it is required technical development toward a new maintenance way capable of performing specialized inspection and maintenance for bad offshore environments and loss cost caused from failures.

### SUMMARY

An aspect of the present disclosure is to provide an offshore plant preventive maintenance system, and an offshore plant preventive maintenance method using the system, capable of applying a preventive maintenance technique, which is a positive and aggressive maintenance mode, to an offshore plant.

In embodiments of the present disclosure, an offshore plant preventive maintenance system is provided.

The offshore plant preventive maintenance system may include an information collection part configured to collect information of offshore plant facility and equipment in real time, a preventive maintenance part configured to execute intelligent maintenance activity based on the collected information, and a virtual operation part configured to verify the intelligent maintenance activity.

The preventive maintenance part may include an intelligent diagnosis part configured to check a failure of the offshore plant facility and equipment, a prognosis part configured to prognosticate and determine deterioration of the offshore plant facility and equipment according to a result of the diagnosis, and a maintenance part configured to propose optimum operation information based on primary information of the offshore plant facility and equipment.

The preventive maintenance may further include a configuration management part configured to match a design condition of the offshore plant facility and equipment with a predetermined design condition.

The preventive maintenance part may further include a preventive maintenance platform.

The preventive maintenance platform may allow information exchange among the intelligent diagnosis part, the prognosis part, and the maintenance part.

The information collection part may collect information of the offshore plant facility and equipment based on a dispersion control mode.

In another embodiment, an offshore plant preventive maintenance method may include collecting information of offshore plant facility and equipment in real time through an information collection part, preventively maintaining the offshore plant facility and equipment by executing intelligent maintenance activity based on the collected information through a preventive maintenance part, and virtually operating the offshore plant equipment and equipment by verifying the intelligent maintenance activity through a virtual operation part.

The preventively maintaining of the offshore plant facility and equipment may include intelligently diagnosing a failure of the offshore plant facility and equipment through the intelligent diagnosis part, prognosticating and determining deterioration of the offshore plant facility and equipment according to a result of the diagnosis through a prognosis part, and maintaining the offshore plant facility and equipment to propose optimum operation information based on primary information of the offshore plant facility and equipment through a maintenance part.

The preventively maintaining of the offshore plant facility and equipment further may include managing a configuration to match a design condition of the offshore plant facility and equipment with a predetermined design condition through a configuration management part.

The preventively maintaining of the offshore plant facility and equipment may further include allowing information exchange among the intelligent diagnosis part, the prognosis part, and the maintenance part through a preventive maintenance part.

The collecting of the information may include collecting the information of the offshore plant facility and equipment based on a dispersion control mode.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a table divisionally showing kinds of maintenance according to property;

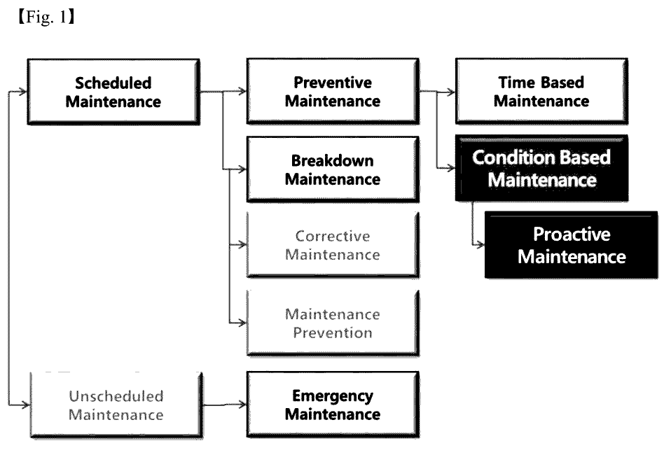

FIG. 2 is a screen showing an operating state of an offshore plant facility in an offshore plant preventive maintenance system according to the present disclosure;

FIG. 3 is a schematic diagram of an offshore plant preventive maintenance system according to the present disclosure;

FIG. 4 illustrates formation of an offshore plant preventive maintenance system according to the present disclosure;

FIG. 5 is a block diagram illustrating formation of an offshore plant preventive maintenance system according to the present disclosure; and

FIG. 6 is a block diagram illustrating a preventive maintenance part according to the present disclosure.

Throughout the drawings, it should be noted that like reference numbers are used to depict the same or similar elements, features, and structures.

### DETAILED DESCRIPTION

Hereinafter, an offshore plant preventive maintenance system and method using the system will be described in conjunction with the accompanied drawings.

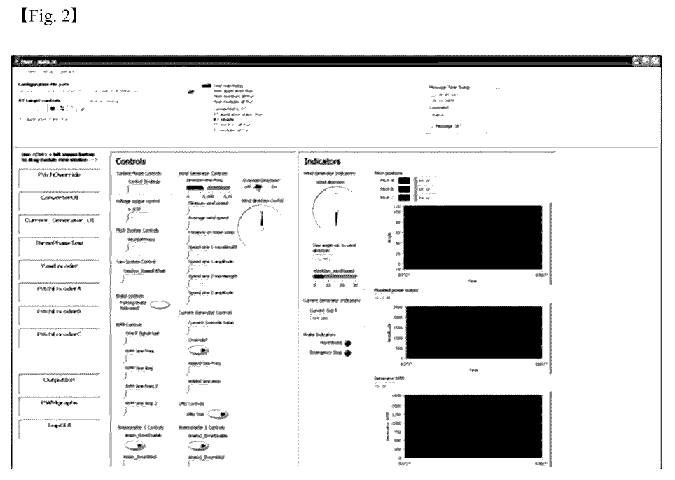

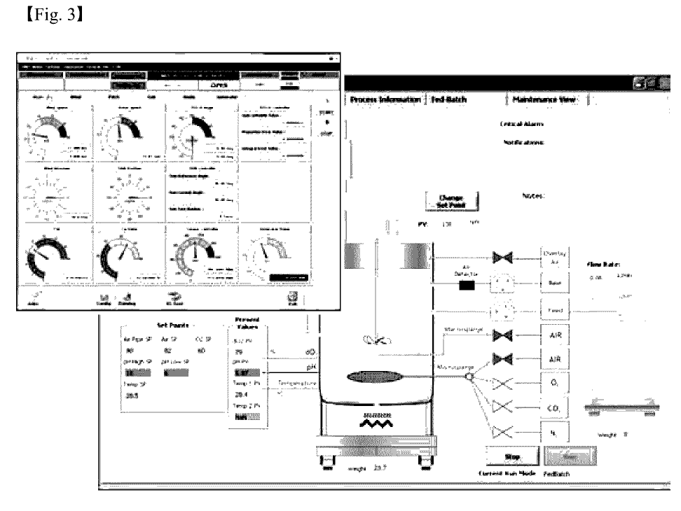

FIG. 2 is a screen showing an operating state of an offshore plant facility in an offshore plant preventive maintenance system according to the present disclosure, and FIG. 3 is a schematic diagram of an offshore plant preventive maintenance system according to the present disclosure.

Referring to FIGS. 2 and 3, a Computerized Maintenance Management System (CMMS), as a facility management information system, having functions of analyzing and evaluating the efficiency of facility management works and the achievements of maintenance works and processing information of facility management through computation to improve the maintenance technology.

The CMMS may include functions of making out worksheets, preparing maintenance schedules, and managing maintenance history, purchase and supply, and stock, as well as tracking facility or components and assets.

The CMMS is positively introduced in merchant ships. The CMMS is similar to a condition based maintenance system (CBMS) in the point of performing maintenance management for facility.

In embodiments of the present disclosure, as shown in FIGS. 2 and 3, an offshore plant preventive maintenance system may allow a user to process optimum information for decision making by providing a function of intelligent prognosis which is not performed in the CMMS.

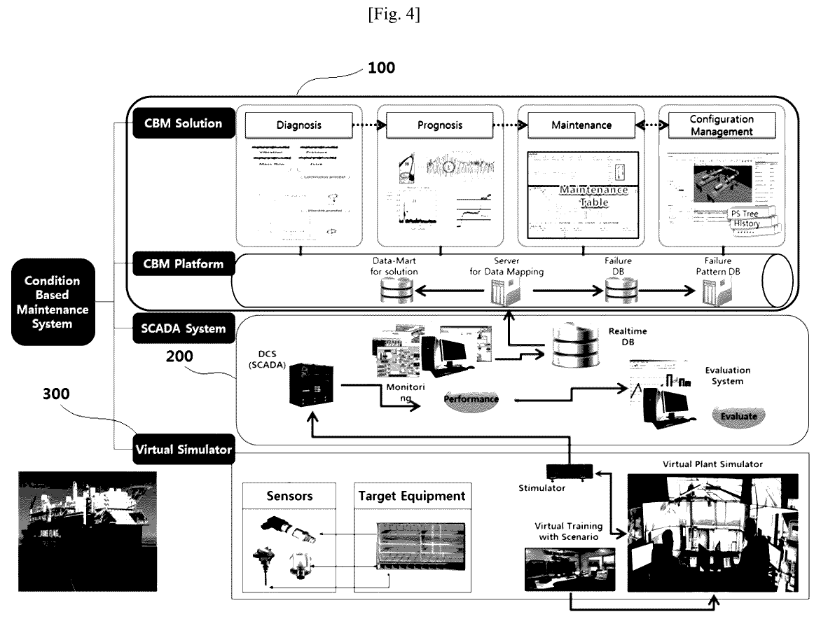

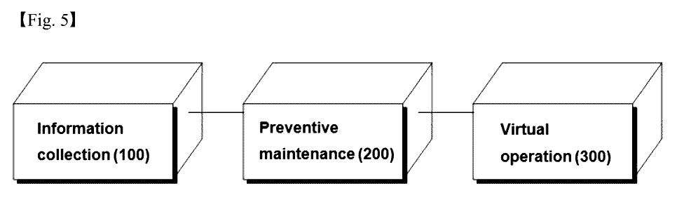

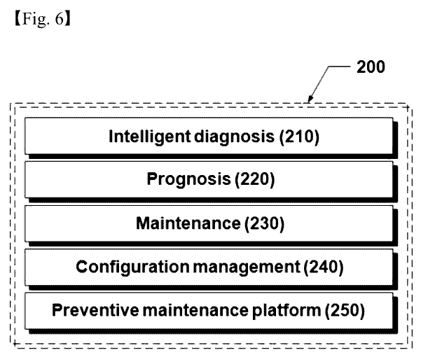

FIG. 4 illustrates formation of an offshore plant preventive maintenance system according to the present disclosure, FIG. 5 is a block diagram illustrating formation of an offshore plant preventive maintenance system according to the present disclosure, and FIG. 6 is a block diagram illustrating a preventive maintenance part according to the present disclosure.

FIGS. 4 to 6 will be referred to describe formation of the offshore plant preventive maintenance system and an offshore plant preventive maintenance system by the formation of the offshore plant preventive maintenance system.

The offshore plant preventive maintenance method according to the present disclosure may be performed in the sequential steps of information collection, preventive maintenance, and virtual operation.

The information collection step may use an information collection part 100 to collect information of an offshore plant facility and equipment in real time.

Subsequently, the preventive maintenance step may use a preventive maintenance part 200 to execute an intelligent maintenance work based on the collected information.

Then, the virtual operation step may use a virtual operation part 300 to verify the intelligent maintenance work.

Now the preventive maintenance step will be described in detail.

The preventive maintenance step may use an intelligent diagnosis part 210, being performed in the sequence of an intelligent diagnosis step for checking failures of an offshore plant facility and equipment, a prognosis step for prognosticating and determining deterioration states of the offshore plant facility and equipment according to a result of the diagnosis through the prognosis part 220, and a maintenance step for proposing optimum operation information based on primary information of the offshore plant facility and equipment through a maintenance part 230.

The preventive maintenance step may further include a configuration management step for matching a design condition of the offshore plant facility and equipment with a predetermined design condition through a configuration management part 240.

At the preventive maintenance step, a preventive maintenance platform 250 may be used to allow information to be exchanged among the intelligent diagnosis part 210, the prognosis part 220, and the maintenance part 230.

The formation of the preventive maintenance part 200 used in the preventive maintenance step will be described hereafter.

The preventive maintenance part 200 may include the intelligent diagnosis part 210 for checking failures of an offshore plat facility and equipment, the prognosis part 220 for prognosticating and determining a deterioration state of the offshore plant facility and equipment, the maintenance part 230 for proposing optimum operation information based on primary information of the offshore plant facility and equipment, a configuration management part 240 for matching a design condition of the offshore plant facility and equipment with a predetermined design condition, and a preventive maintenance platform 250.

The intelligent diagnosis part 210 will be now described.

The intelligent diagnosis part 210 may monitor a status of an offshore plant facility in real time and then may perform diagnosis for predicting failures that may occur.

The intelligent diagnosis part 210 may be formed of independent functions for processing signals and checking a status of facility based on processed signals.

The intelligent diagnosis part 210 may process signal data, which is obtained from a sensor by analyzing failure modes of primary equipment of an offshore plant, and may detect and determine abnormal symptoms of the equipment through a diagnosis algorithm.

The prognosis part 220 will be described hereafter.

The prognosis part 220 may be driven according to a result of the diagnosis and may determine deterioration by analyzing data which is collected from an offshore plant.

By utilizing the diagnosis, it may predict the functionality of an offshore plant equipment/facility based on periodic reflections or events with remaining lifetime and failure probability of the equipment/facility.

And, the prognosis part 220 may support the decision making utilized in optimizing maintenance schedules.

The prognosis part 220 may obtain diagnosis data, which corresponds to abnormal symptoms, from a result of the diagnosis to set failure-involved critical limits, and may estimate a trend line of abnormal symptoms to prognosticate the remaining lifetime.

During this, it may be permissible to use a prognosis algorithm for estimating a failure probability density function, a reliability function, and an unreliability function.

The maintenance part 230 will be described hereafter.

The maintenance part 230 may analyze primary information of an offshore plant equipment/facility through a technique of evaluating economic efficiency, and then may propose the optimum maintenance way, procedure, and period through the analysis.

The primary information may include motion data during works of primary factors, causes, characteristics, effects, results, and hazard analysis data of working system failures, and maintenance cases.

Through the analysis, it may be allowable to maximize the efficiency of preventive maintenance by reducing an increase of facility/equipment working time and dissipation of component replacement cost.

The maintenance part 230 may propose safety means and a maintenance plan for preventing failures trough evaluation of criticality and severity based on failure patterns and scenario.

The configuration management part 240 will be described hereafter.

The configuration management part 240 may maintain a matching state with design standard/requirement, design configuration, and physical configuration in order to improve the accuracy for operation and maintenance of an offshore plant.

The configuration management part 240 may act as the basis for a solution of preventive maintenance, may reflect various information requirements for configurations, and may allow the preventive maintenance solution to use uniform information by providing a process and workflow for the configuration modification.

The preventive maintenance platform 250 will be described hereafter.

The preventive maintenance platform 250 may consolidate system processes for the diagnosis, prognosis, and maintenance steps for assisting the decision making involved in preventive maintenance, and may manage information shared by the steps.

The preventive maintenance platform 250 may transfer Information provided from the information collection part 100 to corresponding systems of the diagnosis, prognosis, and maintenance steps, and may totally manage information exchange between the systems.

The preventive maintenance platform 250 may work based on the configuration management system, and may drive a preventive maintenance process by detecting abnormal symptoms arising from a SCADA system. Additionally, the preventive maintenance platform 250 may even work by an input of a user at need.

The preventive maintenance 250 may provide an easy flow of systemic information for each step, and may provide various assistant services involved in the preventive maintenance.

Through the aforementioned formation and method, embodiments of the present disclosure may be advantageous to development of a maintenance system applying a preventive maintenance technique, which is not a general maintenance mode but a positive and aggressive maintenance mode, to an offshore plant.

Additionally, embodiments of the present disclosure may provide the basis capable of developing a maintenance system minimizing bad offshore operation environment and loss cost caused from failures, as well as allowing economical usage of expensive offshore plant equipment.

Additionally, embodiments of the present disclosure may provide an intelligent preventive function, which is not performed in a CMMS, to allow a user to provide optimum decision making information involved in maintenance activity, improving an operation environment for an offshore plant facility and equipment.

While embodiments of the present disclosure have been shown and described with reference to the accompanying drawings thereof, it will be understood by those skilled in the art that various changes and modifications in form and details may be made therein without departing from the spirit and scope of the present disclosure as defined by the appended claims and their equivalents. For example, it may be allowable to achieve desired results although the embodiments of the present disclosure are preformed in other sequences different from the descriptions, and/or the elements, such as system, structure, device, circuit, and so on, are combined or assembled in other ways different from the descriptions, replaced or substituted with other elements or their equivalents.

Therefore, other implementations, other embodiments, and equivalents of the appended claims may be included in the scope of the appended claims.

What is claimed is:

1. An offshore plant preventive maintenance system comprising:
an information collection part configured to collect information of offshore plant facility and equipment in real time;
a preventive maintenance part configured to execute intelligent maintenance activity based on the collected information; and
a virtual operation part configured to verify the intelligent maintenance activity.

2. The offshore plant preventive maintenance system of claim 1, wherein the preventive maintenance part comprises:
an intelligent diagnosis part configured to check a failure of the offshore plant facility and equipment;
a prognosis part configured to prognosticate and determine deterioration of the offshore plant facility and equipment according to a result of the diagnosis; and
a maintenance part configured to propose optimum operation information based on primary information of the offshore plant facility and equipment.

3. The offshore plant preventive maintenance system of claim 2, wherein the preventive maintenance further comprises:
a configuration management part configured to match a design condition of the offshore plant facility and equipment with a predetermined design condition.

4. The offshore plant preventive maintenance system of claim 2, wherein the preventive maintenance part further comprises a preventive maintenance platform,
wherein the preventive maintenance platform is configured to allow information exchange among the intelligent diagnosis part, the prognosis part, and the maintenance part.

5. The offshore plant preventive maintenance system of claim 1, wherein the information collection part is configured to collect information of the offshore plant facility and equipment based on a dispersion control mode.

6. An offshore plant preventive maintenance method comprising:
collecting information of offshore plant facility and equipment in real time through an information collection part;
preventively maintaining the offshore plant facility and equipment by executing intelligent maintenance activity based on the collected information through a preventive maintenance part; and
virtually operating the offshore plant equipment and equipment by verifying the intelligent maintenance activity through a virtual operation part.

7. The offshore plant preventive maintenance method of claim 6, wherein the preventively maintaining of the offshore plant facility and equipment comprises:
intelligently diagnosing a failure of the offshore plant facility and equipment through the intelligent diagnosis part;
prognosticating and determining deterioration of the offshore plant facility and equipment according to a result of the diagnosis through a prognosis part; and
maintaining the offshore plant facility and equipment to propose optimum operation information based on primary information of the offshore plant facility and equipment through a maintenance part.

8. The offshore plant preventive maintenance method of claim 7, wherein the preventively maintaining of the offshore plant facility and equipment further comprises:
managing a configuration to match a design condition of the offshore plant facility and equipment with a predetermined design condition through a configuration management part.

9. The offshore plant preventive maintenance method of claim 7, wherein the preventively maintaining of the offshore plant facility and equipment further comprises:
allowing information exchange among the intelligent diagnosis part, the prognosis part, and the maintenance part through a preventive maintenance part.

10. The offshore plant preventive maintenance method of claim 6, wherein the collecting of the information comprises:
collecting the information of the offshore plant facility and equipment based on a dispersion control mode.
